(19) United States
(12) Patent Application Publication
(10) Pub. No.: US 2021/0162985 A1
(43) Pub. Date: Jun. 3, 2021

(54) SYSTEM FOR ASSISTING PARKING A VEHICLE AND METHOD FOR THE SAME

(71) Applicants: HYUNDAI MOTOR COMPANY, Seoul (KR); KIA MOTORS CORPORATION, Seoul (KR)

(72) Inventors: Javier ROMERO LEON, Saline, MI (US); Susan SHAW, Plymouth, MI (US); Brian PHELPS, Ypsilanti, MI (US)

(73) Assignees: HYUNDAI MOTOR COMPANY, Seoul (KR); KIA MOTORS CORPORATION, Seoul (KR)

(21) Appl. No.: 16/701,460

(22) Filed: Dec. 3, 2019

(51) Int. Cl. B60W 30/06; B62D 15/02; B60R 11/04; B60Q 9/00; G06K 9/00

(52) U.S. Cl. CPC B60W 30/06; B62D 15/028; B60R 11/04; B60W 2540/04; G06K 9/00812; B60W 2420/42; B60Q 9/00

(57) ABSTRACT

A system for assisting parking a vehicle and a method for the same are provided. The method may include: receiving, by a user interface, a request signal for assisting the parking of the vehicle in the parking space from a user of the vehicle; activating, by a controller, a parking assist feature of the vehicle when the request signal is received; detecting, by a plurality of cameras, a plurality of predetermined locators in the parking space, wherein the plurality of predetermined locators are pre-selected before the parking assist feature is activated; calculating, by the controller, a driving distance and a driving maneuver from the vehicle to a predetermined location of the parking space; and providing, by the controller, a steering instruction to the predetermined location of the parking space to the user interface based on the calculated driving distance and the calculated driving maneuver.

### TECHNICAL FIELD

The present disclosure relates to systems and methods for assisting parking a vehicle in a parking space.

### BACKGROUND

The statements in this section merely provide background information related to the present disclosure and may not constitute prior art.

As more vehicles are equipped with an intelligent parking assist system, the intelligent parking assist system is becoming an essential feature of today's automobile industry.

Currently, many drivers use mirrors or a hanging tennis ball in their parking garage to gauge distances from the vehicle to a desired parking location in the parking garage. However, the driver may not be able to park the vehicle at the same location every time by relying solely on these items. As a result, the driver may need to park the vehicle again when there is not enough space to exit the vehicle or open doors, or sometimes the driver may damage the vehicle or even household items in the garage, especially if the parking garage is filled with a number of household items (e.g., lawnmower, bicycles, trash bin, shelf, or the like). Accordingly, more advanced technologies may be desirable in order to provide the driver with a more accurate expectation of a parking location whenever the vehicle is parked in the garage.

### SUMMARY

As most vehicles currently include cameras and sensors, a driver may be able to park a vehicle in a desired parking location with the aid of a plurality of sensors and cameras.

In one aspect of the present disclosure, a method for assisting parking of a vehicle in a parking space is provided. One form of a method includes receiving, by a user interface, a request signal for assisting the parking of the vehicle in the parking space from a user of the vehicle; activating, by a controller, a parking assist feature of the vehicle when the request signal is received; detecting, by a plurality of cameras, a plurality of predetermined locators in the parking space, wherein the plurality of predetermined locators are pre-selected before the parking assist feature is activated; calculating, by the controller, a driving distance and a driving maneuver from the vehicle to a predetermined location of the parking space; and providing, by the controller, a steering instruction to the predetermined location of the parking space to the user interface based on the calculated driving distance and the calculated driving maneuver.

Detecting the plurality of predetermined locators include capturing, by the plurality of cameras, an image of the parking space.

Calculating the driving distance and the driving maneuver may include identifying, by the controller, the plurality of predetermined locators in the parking space from the image of the parking space by analyzing the image of the parking space; determining, by the controller, a position of the vehicle and an orientation of the vehicle based on the analyzed image; and calculating, by the controller, the driving distance and the driving maneuver from the vehicle to the predetermined location of the parking space by comparing the position and the orientation with the predetermined location of the parking space.

In some forms of the present disclosure, the parking space may be a parking garage.

In some forms of the present disclosure, the plurality of predetermined locators may include at least two predetermined locators of the plurality of predetermined locators selected from among non-moving objects and non-moving marks located in the parking space.

In some forms of the present disclosure, the method further includes determining, by the controller, whether the vehicle is located within a predetermined distance from the plurality of predetermined locators; and when the vehicle is determined to be located within the predetermined distance from the plurality of predetermined locators, transmitting, to the user interface, a warning signal.

In some forms of the present disclosure, the method further includes determining, by the controller, whether the vehicle is located within the predetermined location of the parking space; and when the vehicle is determined not to be located at the predetermined location of the parking space, re-identifying the plurality of predetermined locators in the parking space from the image of the parking space.

In some forms of the present disclosure, providing the steering instruction includes moving, by the controller, the vehicle to the predetermined location of the parking space based on the calculated driving distance and the calculated driving maneuver when the vehicle has a self-parking feature.

In another aspect of the present disclosure, a system for assisting parking of a vehicle in a parking space is provided. In one form, a system may include a user interface configured to receive a request signal for assisting the parking of the vehicle in the parking space from a user of the vehicle; a plurality of cameras configured to detect a plurality of predetermined locators in the parking space, wherein the plurality of predetermined locators are pre-selected before a parking assist feature of the vehicle is activated; a controller configured to activate the parking assist feature when the request signal is received, calculate a driving distance and a driving maneuver from the vehicle to a predetermined location of the parking space; and provide, to the user interface, a steering instruction to the predetermined location of the parking space based on the calculated driving distance and the calculated driving maneuver.

When detecting the plurality of predetermined locators, the plurality of cameras may be configured to capture an image of the parking space.

When calculating the driving distance and the driving maneuver, the controller may be configured to identify the plurality of predetermined locators in the parking space from the image of the parking space by analyzing the image of the parking space; determine a position of the vehicle and an orientation of the vehicle based on the analyzed image; and calculate the driving distance and the driving maneuver from the vehicle to the predetermined location of the parking space by comparing the position and the orientation with the predetermined location of the parking space.

In some forms of the present disclosure, the parking space may be a parking garage.

In some forms of the present disclosure, the plurality of predetermined locations may include at least two predetermined locators of the plurality of predetermined locators selected from among non-moving objects and non-moving marks located in the parking space.

In some forms of the present disclosure, the controller may be configured to determine whether the vehicle is located within a predetermined distance from the plurality of predetermined locators, and to transmit, to the user interface, a warning signal when the vehicle is determined to be located within the predetermined distance from the plurality of predetermined locators.

In some forms of the present disclosure, the controller may be configured to determine whether the vehicle is located at the predetermined location of the parking space, and to re-identify the plurality of predetermined locators in the parking space from the image of the parking space when the vehicle is determined not to be located at the predetermined location of the parking space.

The controller may be further configured to move the vehicle to the predetermined location of the parking space based on the calculated driving distance and the calculated driving maneuver when the vehicle has a self-parking feature.

The system and method for assisting parking the vehicle described herein may allow a driver to park the driver's vehicle in the exact same location of the driver's parking garage each time the parking assist feature is activated. As a result, the vehicle may be always parked at a predetermined distance and a predetermined location from the predetermined locators in the parking garage, which enables the driver to secure enough space to walk out of the vehicle and to open vehicle doors without damaging items located in the parking garage or damaging their vehicle.

In addition, the driver may be able to change the setting of the parking assist feature if needed. For example, the driver may need to adjust the predetermined location of the parking garage where the driver desires the vehicle to be parked when the driver has new items in the parking garage that might take up more or less space.

Furthermore, when the driver is not experienced in parking the vehicle, especially in a very tight space, the described parking assist feature would help the driver to avoid any possible damage on the vehicle that might be caused by the driver's lack of experience if the parking assist feature is activated.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing key components implemented in a system that assists parking of a vehicle in a parking space in one form of the present disclosure;

FIG. 2 is a flowchart describing steps of a method for assisting parking of the vehicle in the parking space by detecting a plurality of predetermined locators in the parking space using the plurality of cameras in one form of the present disclosure;

FIG. 3 is a diagram illustrating a process of determining a position and an orientation of the vehicle as well as positions of a plurality of predetermined locators in one form of the present disclosure.

FIG. 4 is a flowchart describing steps of pre-setting a predetermined location of the parking space in one form of the present disclosure.

FIG. 5 is a diagram illustrating steps of pre-setting the parking assist feature by selecting the plurality of predetermined locators in one form of the present disclosure.

FIG. 6 is a diagram illustrating an overall operation of the parking assist feature after pre-setting the parking assist feature in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout this specification and the claims which follow, unless explicitly described to the contrary, the word “comprise” and variations such as “comprises” or “comprising” will be understood to imply the inclusion of stated elements but not the exclusion of any other elements.

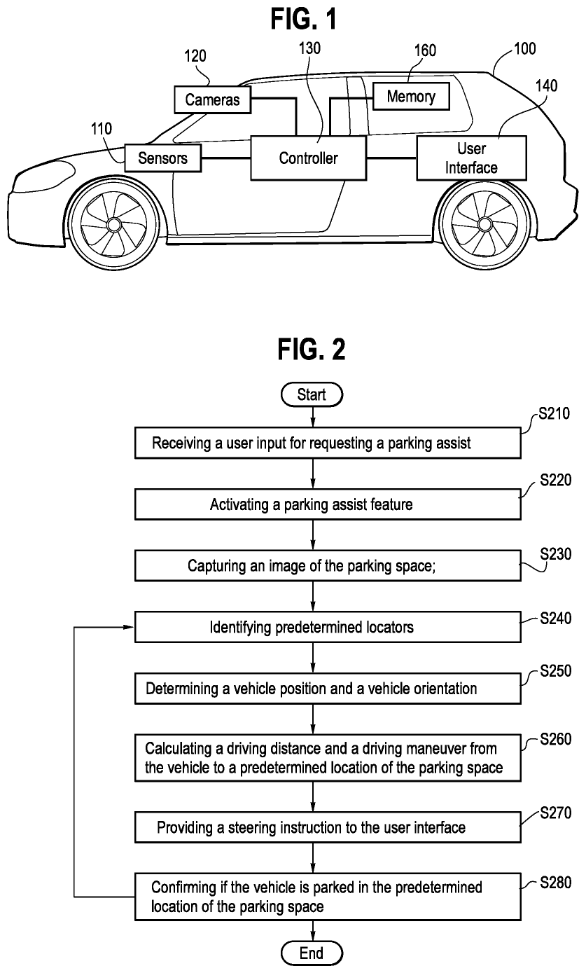

FIG. 1 is a block diagram showing key components implemented in a system that assists parking of a vehicle 100 in a parking space in some forms of the present disclosure.

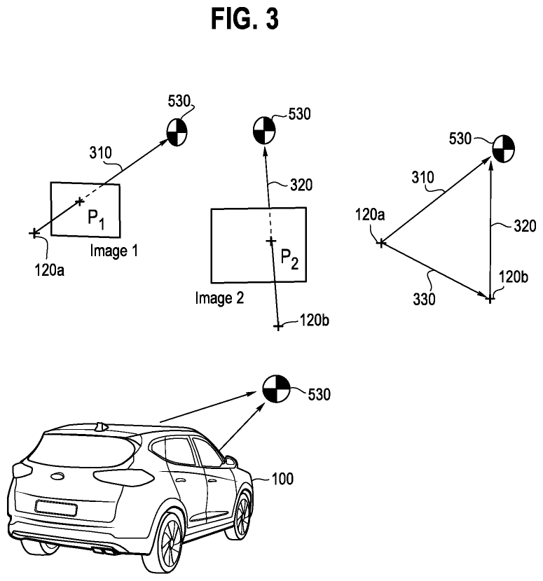

A plurality of cameras 120 of the vehicle 100 detects a plurality of predetermined locators in the parking space. The plurality of predetermined locators may refer to at least two non-moving, fixed objects in the parking space that have been pre-selected by the user before the user starts using the parking assist feature. The plurality of predetermined locators may also refer to any type of stickers or marks in the parking space, or any markings that can be identified by the plurality of cameras 120. For example, the user may place a number of stickers in the parking space when setting up the parking assist feature such that the plurality of cameras 120 detects the placed stickers in the parking space when the parking assist feature is activated. In some forms of the present disclosure, the plurality of predetermined locators may be (i) the selected fixed objects, (ii) the selected marks, or (iii) any combination of the fixed objects and the marks. In some forms of the present disclosure, a device (i.e., projector) in the parking space may be used to project a pattern that would be identified as a different form of locators such that the projected pattern is detected by the plurality of cameras 120 or the plurality of sensors 130 depending on the circumstances. The plurality of cameras 120 may also be used to capture an image of the parking space and to determine a current position of the vehicle 100 as well as the positions of the plurality of predetermined locators, which will be explained in connection with FIG. 3.

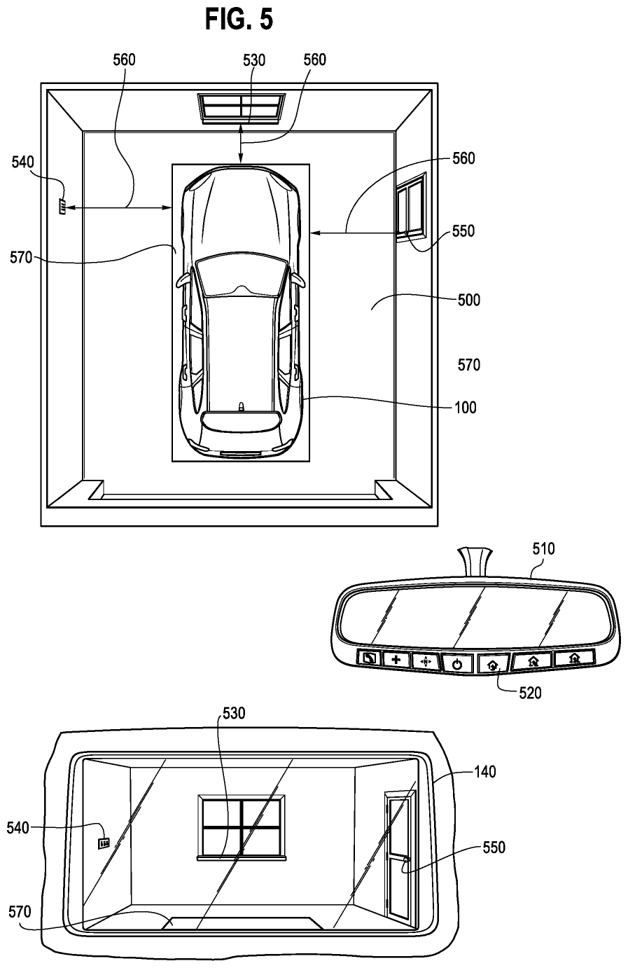

The controller 130 generally receives and transmits information to other components in the vehicle 100 (e.g. user interface 140, sensors 110, cameras 120). For example, the controller 130 receives, from a user interface 140, a request for assisting the parking of the vehicle 100 in the parking space. The controller 130 then transmits a request for detecting the plurality of predetermined locators in the parking space to the plurality of cameras 120 when the controller 130 activates the parking assist feature of the vehicle 100. The controller 130 may also transmit a steering instruction to the user interface 140 when the controller 130 calculates a driving distance and a driving maneuver from the vehicle 100 to a predetermined location of the parking space. In some forms of the present disclosure, the controller 130 may use a process of triangulation to determine the position of the plurality of predetermined locators. The predetermined location of the parking space 570 (shown in FIG. 5) may refer to a desired location of the parking space where the user wants the vehicle 100 to be parked in the parking space. In other words, the predetermined location of the parking space 570 may be equivalent to a location where the vehicle 100 is parked within a predetermined distance 560 from predetermined locators 530, 540, 550 in the parking garage 500 (shown in FIG. 5). The predetermined distance 560 refers to a distance from the vehicle 100 located in the predetermined location 570 of the parking garage 500 to the plurality of predetermined locators 530, 540, 550 (shown in FIG. 5)

The term controller 130 refers to a hardware device that includes a memory and a processor configured to execute one or more steps. Examples of the controller 130 may include, but are not limited to, a field-programmable gate array (FPGA), any integrated circuit (IC) and programmable read-only memory (PROM) chips. The memory is configured to store algorithmic steps and the processor is specifically configured to execute the algorithmic steps to perform one or more processes which are described further below.

Furthermore, the processor executing the algorithmic steps may be embodied as non-transitory computer readable media on a computer readable medium containing executable program instructions executed by a processor, a controller, or the like. Examples of computer readable media include, but are not limited to, ROM, RAM, compact disc (CD) ROMs, magnetic tapes, floppy disks, flash drives, smart cards, and optical data storage devices. The computer readable recording medium can also be distributed in network coupled computer systems so that the computer readable media are stored and executed in a distributed fashion.

The user interface 140 receives an input from the user of the vehicle 100 who wants to activate the parking assist feature of the vehicle 100 in the parking space. The parking space may refer to any space, including but not limited to a parking garage or a designated parking spot, where the user is able to place marks on a certain area of the parking space or the user can designate non-movable, fixed objects for reference in the parking space. The user interface 140 may be any type of visual displays capable of displaying the steering instruction to the user. In some forms of the present disclosure, the user interface 140 may be any type of audio inputs and outputs capable of providing the steering instruction to the user in an audio format. For example, when the vehicle 100 is equipped with voice recognition technology (i.e., Apple Siri, Amazon Alexa, Google Assistant, or the like), the user of the vehicle 100 may be able to communicate through the voice recognition technology in order to activate the parking assist feature. In some forms of the present disclosure, when the vehicle 100 includes a motion sensor, the motion sensor may transmit a request for the parking assist feature to the controller 130 by detecting a motion of the user to activate the parking assist feature.

The plurality of sensors 110 may be used to determine whether the vehicle 100 approaches the predetermined locators too closely and to provide a warning signal to the user through the user interface 140 when the plurality of sensors 110 determines that the vehicle 100 approaches the predetermined locators too closely or that the vehicle is within a predetermined distance 560 (shown in FIG. 5). The plurality of sensors 110 may be used along with the plurality of cameras 120 to determine a driving distance from the vehicle 100 to the predetermined location of the parking space. In some forms of the present disclosure, the plurality of sensors 110 may be used standalone, or together with the plurality of cameras 120, to detect the plurality of predetermined locators. In that case, different types of sensors may be used, including but not limited to, a LiDAR sensor, a wireless magnetometer, a wireless ultrasonic sensor, a radar sensor, an optical sensor, and measuring light grid.

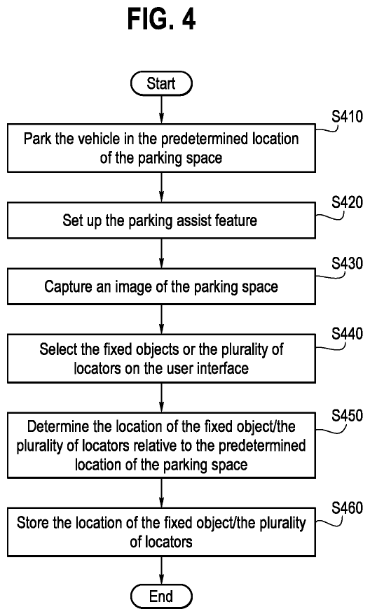

The memory 160 stores each position of the predetermined locators when the parking assist feature is pre-set as described in FIG. 4. In some forms of the present disclosure, when pre-setting the parking assist feature before it is used, the memory 160 may also store the predetermined distance 560 (shown in FIG. 5) to ensure that the vehicle 100 is parked at the exact same location of the parking garage 500 (shown in FIG. 5) each time the vehicle 100 is parked using the parking assist feature.

FIG. 2 is a flowchart describing steps of a method for assisting parking of the vehicle in the parking space by detecting a plurality of predetermined locators in the parking space using the plurality of cameras in some forms of the present disclosure. Each step of assisting parking of the vehicle in the parking space will be explained below in detail.

The controller 130 receives a request to assist a parking of the vehicle 100 from the user via the user interface 140 (S210). This request may be input to the user interface 140 based on a user input (e.g. microphone, touchscreen, keyboard, audio, pushing a button, a gesture/motion, or the like). Moreover, the request may be in various forms. For example, the input may be any type of audio inputs capable of receiving the request in an audio format. For example, when the vehicle 100 is equipped with voice recognition technology (e.g., Apple Siri, Amazon Alexa, Google Assistant, or the like), the user of the vehicle 100 may be able to communicate through the voice recognition technology in order to activate the parking assist feature. In another example, when the vehicle 100 includes a motion sensor, the motion sensor may transmit a request for the parking assist feature to the controller 130 by detecting a motion of the user to activate the parking assist feature. Also, this request may be triggered automatically if a Global Positioning System (GPS) navigation unit of the vehicle 100 determines that the vehicle 100 is positioned at pre-set coordinates near the parking space.

When the request to assist the parking of the vehicle 100 is received, the controller 130 activates the parking assist feature (S220) that must be preset by the user before using the parking assist feature for the first time. The details of presetting the parking assist feature will be described below with reference to FIG. 4.

The controller 130 then controls the plurality of cameras 120 to capture an image of what the plurality of cameras 120 are detecting in the parking space (S230).

The controller 130 then analyzes the captured image of the parking space to locate the plurality of predetermined locators that have been previously set by the user before the parking assist feature is used for the first time (S240). The process of locating the plurality of predetermined locators will be explained in greater detail with reference to FIG. 3.

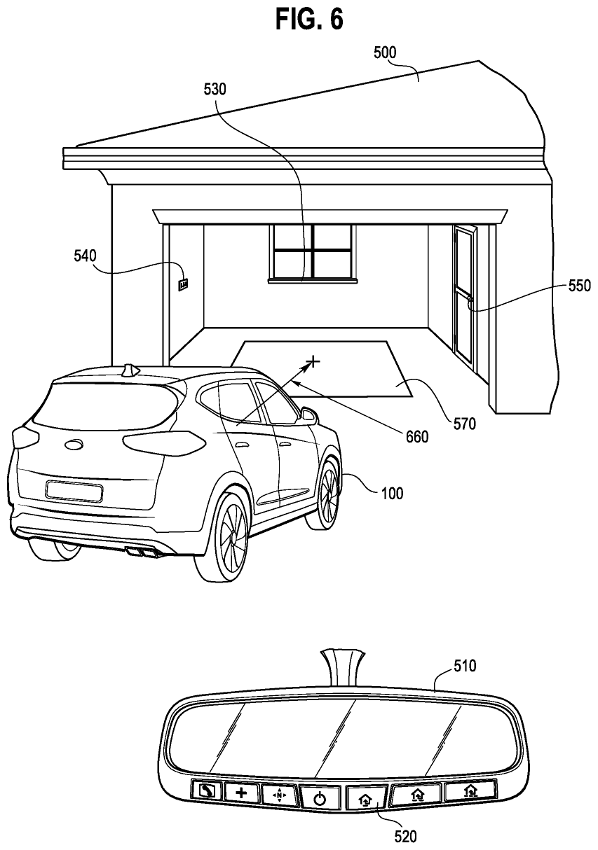

The controller 130 may determine a current position of the vehicle 100 and an orientation of the vehicle 100 based on the analyzed image (S250). The controller 130 then calculates a driving distance and a driving maneuver from the vehicle 100 to the predetermined location of the parking space 570 (shown in FIG. 5) by comparing the current position of the vehicle 100 and the orientation of the vehicle 100 with the predetermined location of the parking space (S260). The driving distance 660 (shown in FIG. 6) may refer to a distance from the vehicle 100 to a predetermined location of the parking space 570 (shown in FIGS. 5 and 6) that the vehicle 100 may need to travel from the moment that the user activates the parking assist feature to the moment that the vehicle 100 is parked at the predetermined location of the parking space 570. The predetermined location of the parking space 570 may refer to a desired location of the parking space where the user wants the vehicle 100 to be parked in the parking space. In other words, the predetermined location of the parking space 570 may be equivalent to a location where the vehicle 100 is parked within a predetermined distance 560 from predetermined locators 530, 540, 550 in the parking garage 500 (shown in FIG. 5). In some forms of the present disclosure, the controller 130 may control the plurality of sensors 110 along with the plurality of cameras 120 to determine the driving distance 660 from the vehicle 100 to the predetermined location of the parking space 570.

The controller 130 provides a steering instruction to the user interface 140 based on the calculated driving distance and the calculated driving maneuver (S270). The steering instruction may be provided to the user interface 140 in various forms (i.e., audio and/or video). In some forms of the present disclosure, when the vehicle is capable of supporting a self-parking feature (or auto parking), the controller 130 activates the self-parking feature and controls the vehicle 100 to park in the predetermined location of the parking space according to the steering instruction.

The controller 130 finally determines whether the vehicle 100 is parked within the predetermined location of the parking space 570 (S280). If so, the controller 130 provides a confirmation signal to the user interface 140 to inform that the vehicle 100 has been parked in the predetermined location of the parking space 570 using the parking assist feature. However, when the vehicle 100 approaches the predetermined locators in the parking space, the controller 130 controls the plurality of sensors 110 and the plurality of cameras 120 to determine whether the vehicle 100 approaches the predetermined locators too closely and to provide a warning signal to the user interface 140 when the plurality of sensors 110 and the plurality of cameras 120 determine that the vehicle 100 approaches the predetermined locators too closely or that the vehicle 100 is within the predetermined distance 560.

In addition, if the controller 130 determines that the vehicle 100 is not located at the predetermined location of the parking space 570, then the controller 130 circles back to S240 and onward until the vehicle 100 is determined to be located at the predetermined location of the parking space 570. The predetermined location of the parking space 570 may be changed, adjusted and restored without restrictions by pre-setting the parking assist feature as explained in FIG. 4.

FIG. 3 is a diagram illustrating a process of determining a position and an orientation of the vehicle as well as positions of a plurality of predetermined locators in some forms of the present disclosure.

In one form of the present disclosure, the controller 130 may use a process of triangulation to determine the position of the plurality of predetermined locators from the vehicle 100. In the first step, the plurality of cameras 120 capture an image of the parking space where the plurality of predetermined locators are provided. The controller 130 then analyzes the captured image to identify a representative point of one locator 530, for example, on the captured image using an image processing. The controller 130 determines a spatial location of the locator 530 from a first camera 120a of the plurality of cameras 120 using imaging parameters that have been previously measured. Specifically, the first camera 120a may identify the center of one locator 530 in the form of coordinates, P1. As a result, a set of potential locations along a first vector 310 may be identified. Similarly, the controller 130 also determines a spatial location of the locator 530 from a second camera 120b of the plurality of cameras 120 by identifying the center of the locator 530 in the form of coordinates, P2 and another set of potential locations along a second vector 320 may be identified.

The controller 130 may then calculate the location of the locator 530 from the vehicle 100 based on the first vector 310/the second vector 320 and a distance between the first camera 120a and the second camera 120b (this distance may be previously known from calibrating the location of the first camera 120a and the second camera 120b), which is depicted as 330. The first camera 120a/the second camera 120b and the locator 530 may be identified as spatial coordinates (X,Y,Z), while P1 and P2 may be identified as pixel coordinates (X,Y). Here, the locator 530 must be on the vector going through the first camera 120a and P1, and on the vector going through the second camera 120b and P2. Based on the calculated location of the locator 530, the controller 130 may also determine the position of the vehicle 100. The same process may apply to other locators 540 and 550.

FIG. 4 is a flowchart describing steps of pre-setting the predetermined location of the parking space in some forms of the present disclosure.

In S410, the user parks the vehicle 100 in the predetermined location of the parking space 570. The predetermined location of the parking space 570 may refer to a desired location of the parking space where the user wants the vehicle 100 to be parked in the parking space each time that the user activates the parking assist feature. The predetermined location of the parking space 570 may be changed, adjusted and restored without restrictions by pre-setting the parking assist feature as explained in FIG. 4.

In S420, the user interface 140 invites the user to set up the parking assist feature. The setup of the parking assist feature may vary depending upon a type of devices that will be used to activate the parking assist feature. For example, when the GPS navigation unit of the vehicle 100 is used to activate the parking assist feature, the user may save the GPS coordinates corresponding to the predetermined parking location of the parking space 570 into the GPS navigation unit. In another form of the present disclosure, when the voice recognition technology is used to activate the parking assist feature, the user may program it into a relevant device (e.g., Apple Siri, Amazon Alexa, Google Assistant, or the like). Also, in another form of the present disclosure, a mobile app may be used to activate the parking assist feature. Alternatively, it may be possible for the user to simply use a garage opener button to activate the parking assist feature.

The controller 130 then controls the plurality of cameras 120 to capture an image of what the plurality of cameras 120 are detecting in the parking space (S430). In some forms of the present disclosure, the controller 130 may control the plurality of sensors 110 to detect specific features of the parking space. In that case, a different type of sensors may be used, including but not limited to, a LiDAR sensor, a wireless magnetometer, a wireless ultrasonic sensor, a radar sensor, an optical sensor, and measuring light grid.

The steps of S440, S450 and S460 will be explained in connection with FIG. 5 below.

FIG. 5 is a diagram illustrating steps of pre-setting the parking assist feature by selecting the plurality of predetermined locators in some forms of the present disclosure.

As described in S410, the user first parks the vehicle 100 in the predetermined location of the parking space 570. In FIG. 5, the parking space may refer to a parking garage 500 of the user.

The garage opener button 520 may be embedded on a rear view mirror 510 of the vehicle 100, or may be installed inside the vehicle 100 separately.

When the vehicle 100 is parked in the parking garage 500 in order to preset the parking assist feature for the first time using the garage opener button 520, the user must press the garage opener button 520 first and then select the non-moving, fixed objects, for example, a window sill 530, a light switch 540, and a door knob 550. If no suitable fixed objects are identified conspicuously, other type of marks such as stickers or markers may be used instead of, or along with, the fixed objects. The user may select at least two different fixed objects (i.e., the window sill 530 and the light switch 540) and it may be desirable for the user to select one fixed object that is located in a front side of the vehicle 100 (i.e., the window sill 530) and another fixed object that is located in either a left side (i.e., the light switch 540) or a right side (i.e., the door knob 550) of the vehicle 100. However, the user is not limited to select one fixed object (or mark) located in the front side of the vehicle 100 and another fixed object (or mark) located in either the left side or the right side of the vehicle 100. Depending on the location of the parking space or the number of cameras 120, two fixed objects (or marks) located from the same side may work as well. In some forms of the present disclosure, the user may decide to select one or more marks (e.g., stickers, markers) entirely or to select any combination of one or more fixed objects and marks depending upon the circumstances. The use of marks/stickers may be beneficial when the fixed objects are not readily detectable by the plurality of cameras 120/the plurality of sensors 110 or when none of the fixed objects (e.g., the window sill 530, the light switch 540, and the door knob 550) is present in the parking garage 500. In some forms of the present disclosure, a device (i.e., projector) in the parking space may be used to project a pattern that would be identified as a different form of locators such that the projected pattern may be detected by the plurality of cameras 120 or the plurality of sensors 130 depending on the circumstances. Here, the predetermined locators may refer to the selected fixed objects, the selected marks/stickers, or any combination of the selected fixed objects and the selected marks.

When selecting at least two fixed objects or marks, the user may, for example, touch a first fixed object (for example, the window sill 530) or a mark on the user interface 140. Subsequently, the user may touch a second fixed object (for example, the light switch 540) or a mark on the user interface 140 (S440). However, the user is not limited to select two fixed objects or marks and selecting more fixed objects or marks may be beneficial to achieve the accuracy of detecting the fixed objects or marks. In some forms of the present disclosure, the controller 130 may automatically select the fixed objects or marks from the captured image of the fixed objects or marks without asking the user to select them.

The controller 130 may determine the positions of the fixed objects or marks, respectively, relative to the predetermined location of the parking space 570 (S450) by using the process explained in FIG. 3.

The user interface 140 transmits information regarding the selected fixed objects 530, 540, 550 or the selected marks to the controller 130. The controller 130 then controls the memory 160 to save the positions of the fixed objects 530, 540, 550 (S460) or the marks to ensure that the vehicle 100 is parked at the exact same location of the parking garage 500 each time the vehicle 100 is parked using the parking assist feature.

FIG. 6 is a diagram illustrating an overall operation of the parking assist feature after pre-setting the parking assist feature in some forms of the present disclosure.

When the vehicle 100 is near the parking garage 500, the user inputs the request for assisting the parking of the vehicle 100 through the user interface 140. The user interface 140 may be any type of inputs capable of receiving the user's input and any type of outputs capable of providing the steering instruction to the user. The user interface 140 may be any type of visual displays capable of displaying the steering instructions to the user. In some forms of the present disclosure, the user interface may be any type of audio inputs and outputs capable of providing the steering instructions to the user in an audio format. For example, when the vehicle 100 is equipped with voice recognition technology (e.g., Apple Siri, Amazon Alexa, Google Assistant, or the like), the user of the vehicle 100 may be able to communicate through the voice recognition feature in order to activate the parking assist feature. In some forms of the present disclosure, when the vehicle 100 includes a motion sensor, the motion sensor may transmit a request for the parking assist feature to the controller 130 by detecting a motion of the user to activate the parking assist feature. In some forms of the present disclosure, the garage opener button 520 positioned on the rear-view mirror 510 may be used to activate the parking assist feature once the garage opener button is set up as explained in FIG. 4.

When the garage opener button 520 is pressed, the plurality of cameras 120 detects the plurality of predetermined locators 530, 540, 550 located in the parking garage 500. The predetermined locators may refer to the selected fixed objects, the selected marks, or any combination of the selected fixed objects and the selected marks. In some forms of the present disclosure, the plurality of sensors 110 may also be used to detect the plurality of predetermined locators 530, 540, 550.

In some forms of the present disclosure, the plurality of sensors 110 and the plurality of cameras 120 may work together to determine a predetermined distance 560. The predetermined distance 560 refers to a distance from the vehicle located in the predetermined location 570 of the parking garage 500 to the plurality of predetermined locators 530, 540, 550. The controller 130 then uses the predetermined distance 560 to determine the driving distance 660 from the vehicle 100 to the predetermined location 570 of the parking garage 500.

Based on the calculated driving distance 660, the controller 130 controls the user interface 140 to provide, to the user, the steering instruction from the vehicle 100 to the predetermined location 570 of the parking garage 500. The driving distance 660 (shown in FIG. 6) may refer to a distance from the vehicle 100 to the predetermined location of the parking space 570 (or, in this case, the parking garage 500) that the vehicle 100 may need to travel from the moment that the user activates the parking assist feature near the parking garage 500 to the moment that the vehicle 100 is parked at the predetermined location 570 of the parking garage 500. The predetermined location 570 of the parking garage 500 may refer to a desired location of the parking garage 500 where the user wants the vehicle 100 to be parked in the parking garage 500. The predetermined location 570 of the parking garage 500 may be equivalent to a location where the vehicle 100 is parked within the predetermined distance 560 from the predetermined locators 530, 540, 550 in the parking garage 500. The steering instruction may be any type of visual outputs displaying the steering instruction to the user. The predetermined distance 560 refers to a distance from the vehicle 100 located in the predetermined location 570 of the parking garage 500 to the plurality of predetermined locators 530, 540, 550. In some forms of the present disclosure, when the vehicle 100 is capable of supporting a self-parking feature (or auto parking), the controller 130 activates the self-parking feature and controls the vehicle 100 to move to the parking garage 500 according to the steering instruction.

The system and method for assisting parking the vehicle described herein may allow a driver to park the driver's vehicle in the exact same location of the driver's parking garage each time the parking assist feature is activated. As a result, the vehicle may be always parked at a predetermined distance and a predetermined location from the predetermined locators in the parking garage, which enables the driver to secure enough space to walk out of the vehicle and to open vehicle doors without damaging items located in the parking garage or damaging their vehicle.

In addition, the driver may be able to change the setting of the parking assist feature if needed. For example, the driver may need to adjust the predetermined location of the parking garage where the driver desires the vehicle to be parked when the driver has new items in the parking garage that might take up more or less space.

Furthermore, if the driver is not experienced in parking the vehicle, especially in a very tight space, the proposed parking assist feature would help the driver to avoid any possible damage on the vehicle that might be caused by the driver's lack of experience when the parking assist feature is activated.

Some forms of the present disclosure may also be embodied as computer readable code on a computer readable recording medium. The computer readable recording medium is any data storage device that can store data which can thereafter be read by a computer system. Examples of the computer readable recording medium may include read-only memory (ROM), random-access memory (RAM), CD-ROMs, magnetic tapes, floppy disks, optical data storage devices, cloud storage device, and carrier waves (such as data transmission over the internet).

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for assisting parking of a vehicle in a parking space, the method comprising:
receiving, by a user interface, a request signal for assisting the parking of the vehicle in the parking space from a user of the vehicle;
activating, by a controller, a parking assist feature of the vehicle when the request signal is received;
detecting, by a plurality of cameras, a plurality of predetermined locators in the parking space, wherein the plurality of predetermined locators are pre-selected before the parking assist feature is activated;
calculating, by the controller, a driving distance and a driving maneuver from the vehicle to a predetermined location of the parking space; and
providing, by the controller, a steering instruction to the predetermined location of the parking space to the user interface based on the calculated driving distance and the calculated driving maneuver.

2. The method of claim 1, wherein detecting the plurality of predetermined locators comprises:
capturing, by the plurality of cameras, an image of the parking space.

3. The method of claim 2, wherein calculating the driving distance and the driving maneuver further comprises:
identifying, by the controller, the plurality of predetermined locators in the parking space from the image of the parking space by analyzing the image of the parking space;
determining, by the controller, a position of the vehicle and an orientation of the vehicle based on the analyzed image; and
calculating, by the controller, the driving distance and the driving maneuver from the vehicle to the predetermined location of the parking space by comparing the position and the orientation with the predetermined location of the parking space

4. The method of claim 1, wherein the parking space is a parking garage.

5. The method of claim 1, wherein the plurality of predetermined locators comprises:
at least two predetermined locators of the plurality of predetermined locators selected from among non-moving objects and non-moving marks located in the parking space.

6. The method of claim 3, wherein the method further comprises:
determining, by the controller, whether the vehicle is located within a predetermined distance from the plurality of predetermined locators; and
when the vehicle is determined to be located within the predetermined distance from the plurality of predetermined locators, transmitting, to the user interface, a warning signal.

7. The method of claim 3, wherein the method further comprises:
determining, by the controller, whether the vehicle is located at the predetermined location of the parking space; and
when the vehicle is determined not to be located at the predetermined location of the parking space, re-identifying the plurality of predetermined locators in the parking space from the image of the parking space.

8. The method of claim 1, wherein providing the steering instruction comprises:
when the vehicle has a self-parking feature, moving, by the controller, the vehicle to the predetermined location of the parking space based on the calculated driving distance and the calculated driving maneuver.

9. A system for assisting parking of a vehicle in a parking space, the system comprising:
a user interface configured to receive a request signal for assisting the parking of the vehicle in the parking space from a user of the vehicle;
a plurality of cameras configured to detect a plurality of predetermined locators in the parking space, wherein the plurality of predetermined locators are pre-selected before a parking assist feature of the vehicle is activated; and
a controller configured to:
activate the parking assist feature when the request signal is received;
calculate a driving distance and a driving maneuver from the vehicle to a predetermined location of the parking space; and
provide, to the user interface, a steering instruction to the predetermined location of the parking space based on the calculated driving distance and the calculated driving maneuver.

10. The system of claim 9, wherein, when detecting the plurality of predetermined locators, the plurality of cameras is configured to:
capture an image of the parking space.

11. The system of claim 10, wherein, when calculating the driving distance and the driving maneuver, the controller is configured to:
identify the plurality of predetermined locators in the parking space from the image of the parking space by analyzing the image of the parking space;
determine a position of the vehicle and an orientation of the vehicle based on the analyzed image; and
calculate the driving distance and the driving maneuver from the vehicle to the predetermined location of the parking space by comparing the position and the orientation with the predetermined location of the parking space.

12. The system of claim 9, wherein the parking space is a parking garage.

13. The system of claim 9, wherein the plurality of predetermined locations comprise:
at least two predetermined locators of the plurality of predetermined locators selected from among non-moving objects and non-moving marks located in the parking space.

14. The system of claim 11, wherein the controller is further configured to:
determine whether the vehicle is located within a predetermined distance from the plurality of predetermined locators; and
transmit, to the user interface, a warning signal when the vehicle is determined to be located within the predetermined distance from the plurality of predetermined locators.

15. The system of claim 11, wherein the controller is further configured to:
determine whether the vehicle is located at the predetermined location of the parking space; and
re-identify the plurality of predetermined locators in the parking space from the image of the parking space when the vehicle is determined not to be located at the predetermined location of the parking space.

16. The system of claim 9, wherein the controller is further configured to:
move the vehicle to the predetermined location of the parking space based on the calculated driving distance and the calculated driving maneuver when the vehicle has a self-parking feature.
